(19) United States
(12) Patent Application Publication
(10) Pub. No.: US 2016/0230047 A1
(43) Pub. Date: Aug. 11, 2016

(54) A COMBINED HOT-MELT ADHESIVE AND PRESSURE SENSITIVE ADHESIVE SYSTEM AND COMPOSITE MATERIALS MADE FROM THE SAME

(71) Applicant: LUBRIZOL ADVANCED MATERIALS, INC., Cleveland, OH (US)

(72) Inventors: Ronald D. Varn, Canton, OH (US); Ioan Marcu, Medina, OH (US); Joseph J. Vontorcik Jr., Broadview Hts., OH (US); Edward W. Ault, Grafton, OH (US); Vic Stanislawczyk, Strongsville, OH (US)

(21) Appl. No.: 15/022,949

(22) PCT Filed: Sep. 22, 2014
(86) PCT No.: PCT/US14/56717

§ 371 Date: Mar. 18, 2016

Related U.S. Application Data
(60) Provisional application No. 61/881,013, filed on Sep. 23, 2013.

(51) Int. Cl. C09J 7/00; C09J 7/02; C09J 7/04

(52) U.S. Cl. CPC C09J 7/00; C09J 7/045; C09J 7/02; C09J 2201/36; C09J 2201/28; C09J 2201/606; C09J 2201/61; C09J 2425/00; C09J 2409/00; C09J 2433/00; C09J 2475/00; C09J 2400/263

(57) ABSTRACT

The disclosed technology relates to a system and approach to achieve temporary adhesion of a hot-melt bonding film to a substrate, including for example a textile, leather, synthetic leather, or nonwoven substrate, so that the hot-melt film stays in place before and during the hot-melt bonding of the substrate to one or more other parts, and can even be re-positioned if needed, and then still stay in place before and during the hot-melt bonding process. In particular, an adhesive system is disclosed comprising a hot-melt adhesive and (ii) a pressure sensitive adhesive, where the hot-melt adhesive is in the form of a continuous film and where the pressure sensitive adhesive is distributed on at least one surface of said continuous film in a discontinuous pattern. In preferred embodiments said hot-melt adhesive comprises a thermoplastic polyurethane and said pressure-sensitive adhesive comprises an acrylic polymer dispersion.

The disclosed technology relates to a system and approach to achieve temporary adhesion of a hot-melt bonding film to a substrate, including, for example, a rigid or non-rigid substrate, so that the hot-melt film stays in place before and during the hot-melt bonding of the substrate to one or more other parts, and can even be re-positioned if needed, and then still stay in place before and during the hot-melt bonding process.

### BACKGROUND OF THE INVENTION

A “bonded” composite element is an element that includes substituent elements (e.g., panels of textile or other materials) that are bonded to one another. Bonding includes bonding through use of glue or other adhesives, through melting and subsequent solidification of a bonding material, and/or through melting and subsequent solidification of a substituent element, but excludes stitching, stapling or similar types of mechanical attachment. Although a bonded composite element may include stitching or other types of mechanical attachment (e.g., to attach the bonded composite element to another element, to shape the bonded composite element), the bonded composite does not rely on that stitching or other mechanical attachment to structurally connect the substituent elements of the bonded composite.

Hot melt adhesive (HMA), also known as hot glue, is often a form of thermoplastic adhesive. HMA is commonly supplied in solid cylindrical sticks of various diameters, designed to be melted in an electric hot glue gun, but may also be used in the form of a film on a substrate that becomes tacky when heated. The HMA is tacky when hot, and solidifies quickly as it cools.

Hot-melt bonding is a process where a HMA is used to bond one or more of the described substituent elements into the described composite. Typically, a substrate to be bonded to another element has a film of HMA on the surface to bonded to the other element. The substrate and element are placed together with the HMA in between in the desired position, and heat and pressure is applied, melting the HMA, and ensuring good contact between the elements being bonded. When the pressure and heat is removed, the substrate and elements are bonded together by the HMA.

Often parts for hot-melt bonding are assembled, layering one more elements together to form an assembly that once hot-melt bonded, will form the desired part. The individual elements must often be perfectly aligned and/positioned for the bonded part to come out as desired. It would be desirable if the pre-bonded parts could have some temporary adhesion to one another, to ensure the parts stay aligned between the time of their assembly and the time they are hot-melt bonded. However, such a temporary adhesion must not interfere with the final hot-melt adhesive bond the part will have after the hot-melt bonding process is complete.

Further, parts are sometimes misaligned and/or improperly assembled during their preparation. Therefore, it would also be desirable for any temporary adhesion between the layers to be strong enough to keep the parts aligned between the time of their assembly and the time they are hot-melt bonded, but not so strong as to prevent workers from adjusting the alignment of parts and/or correcting any improper assemblies that are seen prior to the hot-melt bonding.

The present technology provides a system and approach to address these needs.

### SUMMARY OF THE INVENTION

The disclosed technology provides an adhesive system that includes (i) a hot-melt adhesive and (ii) a pressure sensitive adhesive, where the hot-melt adhesive is in the form of a continuous film and where the pressure sensitive adhesive is distributed on at least one surface of said continuous film in a discontinuous pattern.

The hot-melt adhesive of the adhesive system may include a thermoplastic polyurethane.

The pressure sensitive adhesive of the adhesive system may include an acrylic polymer dispersion.

The pressure sensitive adhesive may cover between 5 and 60 percent of the surface of said continuous film on which it is present.

The disclosed technology also provides an adhesive article which includes a substrate, and an adhesive system on a first major surface of the substrate, the adhesive system includes: (i) a hot-melt adhesive; and (ii) a pressure sensitive adhesive; where the hot-melt adhesive is in the form of a continuous film on said first major surface of the substrate; and where the pressure sensitive adhesive is present on the film of hot-melt adhesive, opposite the substrate, in the form of a discontinuous layer.

The hot-melt adhesive of the adhesive article may include a thermoplastic polyurethane.

The pressure sensitive adhesive of the adhesive article may include an acrylic polymer dispersion.

The pressure sensitive adhesive of the adhesive article may covers between 5 and 60 percent of the surface of said continuous film on which it is present.

The substrate may include one or more films, sheets, membranes, filters, nonwoven or woven fibers, hollow or solid beads, bottles, plates, tubes, rods, pipes, wafers, or any combination thereof.

The substrate of the adhesive article may be a multilayer substrate.

The disclosed technology also provides an article that includes one or more parts and at least one adhesive article, wherein said adhesive article, through the application of pressure, temperature, or both, combines with said parts to form said article; wherein said adhesive article includes a substrate, and an adhesive system on a first major surface of the substrate, where the adhesive system includes: (i) a hot-melt adhesive; and (ii) a pressure sensitive adhesive; where the hot-melt adhesive is in the form of a continuous film on said first major surface of the substrate; and where the pressure sensitive adhesive is present on the film of hot-melt adhesive, opposite the substrate, in the form of a discontinuous layer.

The hot-melt adhesive of the article may include a thermoplastic polyurethane.

The pressure sensitive adhesive of the article may include an acrylic polymer dispersion.

The pressure sensitive adhesive of the article may cover between 5 and 60 percent of the surface of said continuous film on which it is present.

The article may include one or more films, sheets, membranes, filters, nonwoven or woven fibers, hollow or solid beads, bottles, plates, tubes, rods, pipes, wafers, or any combination thereof.

The substrate of the article may be a multilayer substrate.

### DETAILED DESCRIPTION OF THE INVENTION

Various preferred features and embodiments will be described below by way of non-limiting illustration.

The disclosed technology provides adhesive systems, adhesive articles made using such adhesive systems, and article made using adhesive articles.

The adhesive systems described herein include (i) a hot-melt adhesive and (ii) a pressure sensitive adhesive, where the hot-melt adhesive is in the form of a continuous film and where the pressure sensitive adhesive is distributed on at least one surface of said continuous film in a discontinuous pattern.

The hot-melt adhesive useful in the present invention includes a thermoplastic polyurethane. The specific hot-melt adhesive and/or the specific thermoplastic polyurethane selected may depend on the application and/or end use in mind, the details of the materials to the bonded, the melt temperature and/or bond strength desired, or some combination of these parameters.

With these parameters in mind, various thermoplastic polyurethanes may be useful as the hot-melt adhesive in the described system, or as a component of the hot-melt adhesive in the described system.

Thermoplastic polyurethanes (TPU), composition thereof, are generally made from the reaction of: a) a polyisocyanate component; b) a polyol component; and c) a chain extender component; where the reaction may or may not be carried out in the presence of a catalyst.

The TPU compositions described herein are made using a polyisocyanate component. The polyisocyanate component includes one or more polyisocyanates. In some embodiments, the polyisocyanate component includes one or more diisocyanates.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates. In other embodiments, the polyisocyanate component includes one or more aliphatic diisocyanates. In some embodiments, the polyisocyanate component is essentially free of, or even completely free of, aromatic diisocyanates.

Examples of useful polyisocyanates include aromatic diisocyanates such as 4,4′-methylenebis(phenyl isocyanate) (MDI), 1,6-hexamethylene diisocyanate (HDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate includes H12MDI.

In some embodiments, the thermoplastic polyurethane is prepared with a polyisocyanate component that includes (or consists essentially of, or even consists of) H12MDI and at least one of MDI, HDI, TDI, IPDI, LDI, BDI, PDI, CHDI, TODI, and NDI.

The TPU compositions described herein are made using b) a polyol component. Polyols include polyether polyols, polyester polyols, polycarbonate polyols, polysiloxane polyols, and combinations thereof.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof.

Suitable hydroxyl terminated polyester intermediates include linear polyesters having a number average molecular weight (Mₙ) of from about 500 to about 10,000, from about 700 to about 5,000, or from about 700 to about 4,000, and generally have an acid number generally less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycol described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from ε-caprolactone and a bifunctional initiator such as diethylene glycol, 1,4-butanediol, or any of the other glycol and/or diol listed herein. In some embodiments, the polycaprolactone polyester polyols are linear polyester diols derived from caprolactone monomers.

Useful examples include CAPA™ 2202A, a 2000 number average molecular weight (Mₙ) linear polyester diol, and CAPA™ 2302A, a 3000 Mₙ linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, hexane diol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5000, or from 1000 or even 2000 to 4000 or even 3000.

Suitable hydroxyl terminated polyether intermediates include polyether polyols derived from a diol or polyol having a total of from 2 to 15 carbon atoms. In some embodiments, the hydroxyl terminated polyether is an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene glycol) comprising water reacted with tetrahydrofuran which can also be described as polymerized tetrahydrofuran, and which is commonly referred to as PTMEG). In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as PolyTHF® B, a block copolymer, and PolyTHF®R, a random copolymer. The various polyether intermediates generally have a number average molecular weight (Mₙ) as determined by assay of the terminal functional groups which is an average molecular weight greater than about 700, such as from about 700 to about 10,000, from about 1000 to about 5000, or from about 1000 to about 2500. In some embodiments, the polyether intermediate includes a blend of two or more different molecular weight polyethers, such as a blend of 2000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5000, or from 400 to 3000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

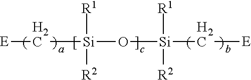

in which: each R¹ and R² are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene glycol), poly(trimethylene oxide), ethylene oxide capped polypropylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include PriplastTM polyester gylcols/polyols commercially available from Croda and Radia® polyester glycols commercially available from Oleon.

The TPU compositions of the invention are made using c) a chain extender component. Chain extenders include diols, diamines, and combinations thereof

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, and hydroxyethyl resorcinol (HER), and the like, as well as mixtures thereof. In some embodiments, the chain extender includes BDO, HDO, 3-methyl-1,5-pentanediol, or a combination thereof. In some embodiments, the chain extender includes BDO. Other glycols, such as aromatic glycols could be used, but in some embodiments the TPUs of the invention are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example, CHDM. In some embodiments, the chain extender used to prepare the TPU is substantially free of, or even completely free of aromatic chain extenders, for example, aromatic cyclic chain extenders. In some embodiments, the chain extender used to prepare the TPU is substantially free of, or even completely free of polysiloxanes.

In some embodiments, the chain extender component includes 1,4-butanediol, 2-ethyl-1,3-hexanediol, 2,2,4-trimethyl pentane-1,3-diol, 1,6-hexanediol, 1,4-cyclohexane dimethylol, 1,3-propanediol, 3-methyl-1,5-pentanediol or combinations thereof. In some embodiments, the chain extender component includes 1,4-butanediol, 3-methyl-1,5-pentanediol or combinations thereof. In some embodiments, the chain extender component includes 1,4-butanediol.

In some embodiments, the hot-melt adhesive includes a polyester polyol based thermoplastic polyurethane (that is a thermoplastic polyurethane made using a polyester polyol and reacting it with one or isocyanates and optionally one or more chain extenders).

In some embodiments, the thermoplastic polyurethane of the hot-melt adhesive has a melt viscosity of 100-300 Pa·s at 170° C. and which includes polycaprolactone segments and further contains hydroxyl groups.

The thermoplastic polyurethane may be a linear polyurethane that is solid at room temperature and which comprises polycaprolactone segments and contains hydroxyl groups. The polyurethane may have a melt viscosity, measured in accordance with DIN 53735, of 100-300 Pa·s, preferably of 100-150 Pa·s, at 170° C. In some embodiments, the thermoplastic polyurethane may have a hydroxyl number of less than 5 mg KOH/g.

In some embodiments, the thermoplastic polyurethane is solid at room temperature and has more particularly a melting point of at least 50° C., typically between 60 and 80° C., or even between 60 and 70° C. The melting point referred to is more particularly the maximum of the curve determined by means of dynamic differential calorimetry (DSC, differential scanning calorimetry) during the heating operation, at which the material undergoes transition from the solid to the liquid state.

The thermoplastic polyurethane may be linear and comprises polycaprolactone segments as a structural element. It may be prepared more particularly by an addition reaction from at least one polycaprolactone diol and at least one diisocyanate having a molecular weight of below 1000 g/mol; in addition, short-chain diols can be used as chain extenders. The addition reaction may be conducted such that the sum of the hydroxyl groups of the polycaprolactone diol and of the chain extender used optionally are present in a stoichiometric excess in relation to the isocyanate groups of the polyisocyanate.

In one embodiment, the thermoplastic polyurethane is a polyurethane chain extended by an alkylene diol, more particularly butane diol, and formed from polycaprolactone diol and a diisocyanate having a molecular weight of below 1000 g/mol.

In such embodiments, the diisocyanate may include 4,4′-, 2,4′- and/or 2,2′-diphenyl-methane diisocyanate and any desired mixtures of these isomers (MDI), 2,4- and 2,6-tolylene diisocyanate and any desired mixtures of these isomers (TDI), 1,6-hexamethylene diisocyanate (HDI), 1-isocyanato-3,3,5-trimethyl-5-isocyanatomethylcyclohexane (i.e. isophorone diisocyanate or IPDI) and perhydro-2,4′- and -4,4′-diphenylmethane diisocyanate (HMDI). In some embodiments, the isocyanate includes MDI.

In one embodiment, the thermoplastic polyurethane has a melt flow index (MFI), measured in accordance with DIN 53735, of 30-100 g/10 minutes, more particularly of 70-90 g/10 minutes.

Suitable thermoplastic polyurethanes include certain ones obtainable under the brand name Pearlbond® from Lubrizol, including Pearlbond® DIPP-523, Pearlbond® 503, Pearlbond® DIPP-521, Pearlbond® 125, and Pearlbond® 501, and also including SKYTHANE® UB410, a TPU HMA available from SK Chemicals and ESTANE® 58271, a TPU HMA available from Lubrizol.

The hot-melt adhesive of the adhesive system will generally be present in the form of a film, and more specifically a continuous film. The thickness of the film is not overly limited. In some embodiments, the film may have a thickness from about 0.1 mil to about 50 mils, or from about 0.5 mil to about 20, or from 0.7 mil to about 10 mils, or even from 1 mil to about 5 mils. When the adhesive system is used to prepare an adhesive article, or an article made from an adhesive article, the hot-melt adhesive may be present in the form of a film on a substrate, where the substrate and the adhesive system may make up the adhesive article, and where the adhesive article may be used to make one or more of the described articles.

The pressure sensitive adhesive useful in the described technology includes rubber based pressure sensitive adhesives, acrylic polymer based pressure sensitive adhesives and combinations thereof. In some embodiments, the pressure sensitive adhesive includes rubber based pressure sensitive adhesive. In some embodiments, the pressure sensitive adhesive includes acrylic polymer based pressure sensitive adhesive, including those in the form of polymeric dispersions.

Useful rubber based pressure sensitive adhesives include those taught in U.S. Pat. No. 5,705,551 (Sasaki et al.) and in U.S. Pat. No. 4,080,348 (Korpman), the disclosures of which are hereby incorporated by reference. Examples of polymeric rubber bases include one or more of styrene-isoprene-styrene polymers, styrene-olefin-styrene polymers including styrene-ethylene/propylene-styrene polymers, polyisobutylene, styrene-butadiene-styrene polymers, polyisoprene, polybutadiene, natural rubber, silicone rubber, acrylonitrile rubber, nitrile rubber, polyurethane rubber, polyisobutylene rubber, butyl rubber, halobutyl rubber including bromobutyl rubber, butadiene-acrylonitrile rubber, polychloroprene, and styrene-butadiene rubber.

A particularly useful rubber based adhesive is that which has a thermoplastic elastomeric component and a resin component. The thermoplastic elastomeric component contains about 55-85 parts of a simple A-B block copolymer wherein the A-blocks are derived from styrene homologs and the B-blocks are derived from isoprene, and about 15-45 parts of a linear or radical A-B-A block copolymer wherein the A-blocks are derived from styrene or styrene homologs and the B-blocks are derived from conjugated dienes or lower alkenes, the A-blocks in the A-B block copolymer constituting about 10-18 percent by weight of the A-B copolymer and the total A-B and A-B-A copolymers containing about 20 percent or less styrene. The resin component consists essentially of tackifier resins for the elastomeric component. In general, any compatible conventional tackifier resin or mixture of such resins may be used. These include hydrocarbon resins, rosin and rosin derivatives, polyterpenes and other tackifiers. The adhesive composition contains about 20-300 parts of the resin component per one hundred parts by weight of the thermoplastic elastomeric component. One such rubber based adhesive is commercially available from Ato Findley, now part of Bostik, under the trade name HM-3210.

Useful acrylic based pressure sensitive adhesives include those taught in U.S. Pat. No. 5,947,917 (Carte), and U.S. Pat. No. 5,164,444 (Bernard, acrylic emulsion), U.S. Pat. No. 5,623,011 (Bernard, tackified acrylic emulsion). It can also be radiation curable mixture of monomers with initiators and other ingredients such as those taught in U.S. Pat. No. 5,232,958 (Ang, UV cured acrylic) and U.S. Pat. No. 5,232,958 (Mallya et al, EB cured). The disclosures of these patents and the pending application as they relate to acrylic adhesives are hereby incorporated by reference.

It is contemplated that any acrylic based polymer capable of forming an adhesive layer with sufficient tack to a substrate may function in the present invention. In certain embodiments, the acrylic polymers for the pressure-sensitive adhesive layers include those formed from polymerization of at least one alkyl acrylate monomer or methacrylate, an unsaturated carboxylic acid and optionally a vinyl lactam. Examples of suitable alkyl acrylate or methacrylate esters include, but are not limited to, butyl acrylate, ethyl acrylate, 2-ethylhexyl acrylate, isooctyl acrylate, isononyl acrylate, isodecyl acrylate, methyl acrylate, methylbutyl acrylate, 4-methyl-2-pentyl acrylate, sec-butyl acrylate, ethyl methacrylate, isodecyl methacrylate, methyl methacrylate, and the like, and mixtures thereof. Examples of suitable ethylenically unsaturated carboxylic acids include, but are not limited to, acrylic acid, methacrylic acid, fumaric acid, itaconic acid, and the like, and mixtures thereof. A preferred ethylenically unsaturated carboxylic acid monomer is acrylic acid. Examples of suitable vinyl lactams include, but are not limited to, N-vinyl caprolactam, 1-vinyl-2-piperidone, 1-vinyl-5-methyl-2-pyrrolidone, vinyl pyrrolidone, and the like, and mixtures thereof.

The hot-melt adhesive and/or the pressure sensitive adhesive may also include a tackifier. Tackifiers, are generally hydrocarbon resins, wood resins, rosins, rosin derivatives, and the like. It is contemplated that any tackifier known by those of skill in the art to be compatible with elastomeric polymer compositions may be used with the present embodiment of the invention. One such tackifier, found to be useful is Wingtack®10, a synthetic polyterpene resin that is liquid at room temperature, and sold by Cray Valley Exton, Pa. Wingtack 95 is a synthetic tackifier resin also available from Cray Valley that comprises predominantly a polymer derived from piperylene and isoprene. Other suitable tackifying additives may include Escorez 1310, an aliphatic hydrocarbon resin, and Escorez 2596, a C5 to C9 (aromatic modified aliphatic) resin, both manufactured by Exxon of Irving, Tex. Of course, as can be appreciated by those of skill in the art, a variety of different tackifying additives may be used to practice the present invention.

In addition to the tackifiers, other additions may be included in the hot-melt adhesive and/or the pressure sensitive adhesive to impart desired properties. For example, plasticizers may be included and they are known to decrease the glass transition temperature of an adhesive composition containing elastomeric polymers. An example of a useful plasticizer is Shellflex® 371, a naphthenic processing oil available from Shell Oil Company of Houston, Tex. Antioxidants also may be included on the adhesive compositions. Suitable antioxidants include Irgafos® 168 and Irganox® 565 available from BASF. Cutting agents such as waxes and surfactants also may be included in the adhesives.

Other optional materials which may be added to the hot-melt adhesive and/or the pressure sensitive adhesive in minor amounts (typically less than about 25% by weight of the overall materials) include pH controllers, medicaments, bactericides, growth factors, wound healing components such as collagen, antioxidants, deodorants, perfumes, antimicrobials and fungicides.

Useful silicone pressure sensitive adhesives include those commercially available from Dow Corning Corp., Medical Products and those available from General Electric. Examples of silicone adhesives available from Dow Corning include those sold under the trade names BIO-PSA X7-3027, BIO-PSA X7-4919, BIO-PSA X7-2685, BIO-PSA X7-3122 and BIO-PSA X7-4502. Additional examples of silicone pressure sensitive adhesives useful in the present invention are described in U.S. Pat. Nos. 4,591,622, 4,584,355, 4,585,836 and 4,655,767, incorporated herein by reference.

The pressure sensitive adhesive is present on top of the hot-melt adhesive. When used in an adhesive article, the pressure sensitive adhesive is present on the hot-melt adhesive and the hot-melt adhesive is present on the substrate. Thus, the adhesive article can be contacted with another element, where the pressure sensitive adhesive would provide initial and/or temporary adhesion between the adhesive article and the element, and then via a hot-melt bonding process, the hot-melt adhesive forms the long term (or even permanent) bond between the adhesive article, or more specifically the substrate of the adhesive article, and the element.

In general, the pressure sensitive adhesive may be described as being present in a discontinuous pattern on the hot-melt adhesive. Where the hot-melt adhesive is in the form of a continuous film, the pressure sensitive adhesive may be present on the film in a part that does not fully cover the hot-melt adhesive, but rather leaves areas where no pressure sensitive adhesive is present and the hot-melt adhesive is left uncovered.

In some embodiments, the pressure sensitive adhesive is in the form of a layer having a plurality of discontinuous adhesive free areas that define a pattern, wherein the pattern is formed simultaneously with the applying of the adhesive layer and a total area of the plurality of discontinuous adhesive-free areas is less than 50%, 25%, 20%, 15%, 10%, or even 5% of a total surface area of the hot-melt adhesive, which may also be in the form of a layer and more specifically a film.

The pressure sensitive adhesive may form a pattern on the hot-melt adhesive. The pressure sensitive adhesive may be applied in any number of patterns. For example, one potential pattern would be a sine wave using either a smooth pattern (rounded waves) or a sharp pattern (triangle shaped waves) closely packed together. In another embodiment, the adhesive forms a continuous network so that the adhesive-free areas are not interconnected. In still other embodiments, the adhesive forms a discontinuous network so that the adhesive-free areas are all interconnected, leaving the pressure sensitive adhesive in the form a dots or other similar discrete shapes.

The pressure sensitive adhesive layer is typically present in coat weight from about 10 to about 80, or from about 15 to about 70, or from about 20 to 60 grams per square meter.

In one embodiment, the pressure sensitive adhesive is in a pattern of a “honeycomb” design. The “honeycomb” design may be achieved in any suitable manner using various adhesive-free shapes in various configurations. For example, the adhesive-free areas are in the form of circular dots, hexagonal dots, square dots, or any geometrical shape. These dots are configured so that they line up in rows or are offset between rows. In one embodiment, the hexagonal dot is offset between rows, and this tends to achieve the desired balance between adhesion coverage and adhesive-free areas.

The described patterns may by prepared by any means know to those in the art. The pattern could be formed by spraying the pressure sensitive adhesive or by melt blowing the pressure sensitive adhesive. The pattern could be formed by printing the adhesive. The printing may be any means that can form the pattern. Examples of useful printing means include gravure, lithographic, screen, or flexographic printing.

As stated above, suitable techniques to apply the adhesive in this discontinuous pattern include gravure coating, spray coating, melt blowing, flexographic printing such as offset flexographic printing or screen printing of adhesives. An added benefit of the printing techniques is the potential to design areas of concentrated pressure sensitive adhesive by increasing the amount of pressure sensitive adhesive in that part of the pattern, or in contrast, areas of minimized pressure sensitive adhesive (and so concentrated hot-melt adhesive bonding) by decreasing the amount of pressure sensitive adhesive in that part of the pattern. Thus, the pattern may be customized to suit the adhesive article in mind and the part and/or article that will eventually be made using the described system and/or article.

The pressure sensitive adhesive, which may be in the form of dots or something similar, may form what may be referred to as a discontinuous layer (or non-continuous layer), and this layer may have a thickness from about 0.1 mil to about 50 mils, or from about 0.5 mil to about 20, or from 0.7 mil to about 10 mils, or even from 1 mil to about 5 mils. This thickness of the discontinuous layer may also be described as the height of the dots and/or the height of the segments of pressure sensitive adhesive.

In other embodiments, the pressure sensitive adhesive layer may have a thickness from 5 to 1000 microns or from 10 to 350 microns.

In still other embodiments, the pressure sensitive adhesive is present as a definite geometric pattern on the consisting of discrete islands on the on the hot-melt adhesive, wherein the islands of the pressure sensitive adhesive have dimensions of from about 0.25 mm by 0.25 mm to about 4 mm by 4 mm, and the uncoated bridges between such islands form a grid, where each bridge may have a width of from about 0.25 mm to about 1.0 mm. In some embodiments, the islands have dimensions of from about 0.50 mm by 0.50 mm to about 3 mm by 3 mm. The bridges may be no wider than 0.75 mm, or even about 0.25 mm to about 0.50 mm. The islands present in the pattern, whether coated areas, or uncoated areas, may be square, circular, triangular, elliptic, rhombic, or other defined geometric shape. The bridges then form a related grid. For example, where the islands are circular, the bridges are narrow between adjacent circles, and the intersection of the bridges is enlarged; where the islands are square, the bridges form diagonally opposed equal lines.

The disclosed technology provides an adhesive system that includes (i) one or more of the hot-melt adhesives described above and (ii) one or more of the pressure sensitive adhesives described above. The hot-melt adhesive may be in the form of a continuous film and where the pressure sensitive adhesive can be distributed on at least one surface of said continuous film in one or more of the patterns described above. Thus, the system can be described in some embodiments as a film of hot-melt adhesive with a pressure sensitive adhesive present on one or more sides of the film in a discontinuous pattern. This system can be used in the assembly of parts, particularly in the assembly of parts made using hot-melt bonding, where the pressure sensitive adhesive can provide initial and/or temporary bonding between the parts during assembly and leading up to the hot-melt bonding process, and where the hot-melt adhesive can then be used to form the primary and/or long term adhesion.

The disclosed technology also provides an adhesive article which includes a substrate, and one or more of the adhesive systems described above. In these embodiments, the adhesive system is present on a substrate. Typically, the substrate is meant to be bonded to one or more additional elements. The substrate and element can be arranged as desired, with the adhesive system present between them. The pressure sensitive adhesive can then be used to provide the initial and/or temporary bonding described above, and then the hot-melt adhesive can provide the primary and/or long term adhesion described above.

The substrate itself is not overly limited. It may be a flexible (i.e. non-rigid) substrate, for example a textile, leather, synthetic leather, or nonwoven substrate. It may be a non-flexible (i.e., rigid) substrate, for example, a fiberglass, metal, plastic, or wooden substrate. It is also noted that in some embodiments the adhesive system described above has a pressure sensitive adhesive layer on both major surfaces of the hot melt adhesive film, and the system is then places between two substrates and used to bond them together.

The disclosed technology also provides an article that includes one or more parts and at least one of the adhesive articles described above.

### EXAMPLES

The technology described herein may be better understood with reference to the following non-limiting prophetic examples.

A set of examples are prepared using the following pressure sensitive adhesives (PSA):

TABLE 1

| PSA | |
|---|---|
| Number | PSA Description |
| P-1 | styrene-isoprene-styrene polymer |
| P-2 | styrene-butadiene rubber |
| P-3 | HM3210 ™ commercially available from Ato Findley, now |
| | part of Bostik |
| P-4 | CARBOTAC ® 2990, an acrylic polymer dispersion |
| | available from Lubrizol. |
| P-5 | CARBOTAC ® 1811, an acrylic polymer dispersion |
| | available from Lubrizol. |

The set of examples also uses the following hot-melt adhesives (HMA):

TABLE 2

| HMA | |
|---|---|
| Number | HMA Description |
| H-1 | PEARLBOND ® 125, a TPU HMA available from Lubrizol. |
| H-2 | PEARLBOND ® 501, a TPU HMA available from Lubrizol. |
| H-3 | PEARLBOND ® 503, a TPU HMA available from Lubrizol. |
| H-4 | SKYTHANE ® UB410, a TPU HMA available from SK |
| | Chemicals. |
| H-5 | ESTANE ® 58271, a TPU HMA available from Lubrizol. |

The set of examples also uses the following designs and/or patterns for the pressure sensitive adhesive on the hot-melt adhesives:

TABLE 3

| Design | |
|---|---|
| Number | Design Description |
| D-1 | Dots, circular, in offset rows, 10% coverage |
| D-2 | Dots, circular, in offset rows, 25% coverage |
| D-3 | Dots, circular, in offset rows, 50% coverage |
| D-4 | Waves, rounded, 10% coverage |
| D-5 | Waves, rounded, 50% coverage |

A summary of the examples in provide in the table below. Each example is prepared using a woven fabric substrate, where the hot-melt adhesive is applied to substrate as a continuous film, 10 mil thick. The pressure sensitive adhesive is then applied onto the hot-melt adhesive film, in the specified pattern, 5 mil thick. Each example is then assembled with an element, where the pressure sensitive adhesive provides the initial and temporary adhesion between the substrate (and/or adhesive article) and the element, and the part is then hot-melt bonded, where the hot-melt adhesive provided the long term bonding between the substrate (and/or adhesive article) and the element.

TABLE 4

| Example | | | |
|---|---|---|---|
| Number | HMA | PSA | Design |
| 1 | H-1 | P-1 | D-1 |
| 2 | H-1 | P-1 | D-2 |
| 3 | H-1 | P-1 | D-3 |
| 4 | H-1 | P-1 | D-4 |
| 5 | H-1 | P-1 | D-5 |
| 6 | H-1 | P-2 | D-1 |
| 7 | H-1 | P-2 | D-2 |
| 8 | H-1 | P-2 | D-3 |
| 9 | H-1 | P-2 | D-4 |
| 10 | H-1 | P-2 | D-5 |
| 11 | H-1 | P-3 | D-1 |
| 12 | H-1 | P-3 | D-2 |
| 13 | H-1 | P-3 | D-3 |
| 14 | H-1 | P-3 | D-4 |
| 15 | H-1 | P-3 | D-5 |
| 16 | H-1 | P-4 | D-1 |
| 17 | H-1 | P-4 | D-2 |
| 18 | H-1 | P-4 | D-3 |
| 19 | H-1 | P-4 | D-4 |
| 20 | H-1 | P-4 | D-5 |
| 21 | H-1 | P-5 | D-1 |
| 22 | H-1 | P-5 | D-2 |
| 23 | H-1 | P-5 | D-3 |
| 24 | H-1 | P-5 | D-4 |
| 25 | H-1 | P-5 | D-5 |
| 26 | H-2 | P-4 | D-1 |
| 27 | H-2 | P-4 | D-2 |
| 28 | H-2 | P-4 | D-3 |
| 29 | H-2 | P-5 | D-1 |
| 30 | H-2 | P-5 | D-2 |
| 31 | H-2 | P-5 | D-3 |
| 32 | H-3 | P-4 | D-1 |
| 33 | H-3 | P-4 | D-2 |
| 34 | H-3 | P-4 | D-3 |
| 35 | H-3 | P-5 | D-1 |
| 36 | H-3 | P-5 | D-2 |
| 37 | H-3 | P-5 | D-3 |
| 38 | H-4 | P-4 | D-1 |
| 39 | H-4 | P-4 | D-2 |
| 40 | H-4 | P-4 | D-3 |
| 41 | H-4 | P-5 | D-1 |
| 42 | H-4 | P-5 | D-2 |
| 43 | H-4 | P-5 | D-3 |
| 44 | H-5 | P-4 | D-1 |
| 45 | H-5 | P-4 | D-2 |
| 46 | H-5 | P-4 | D-3 |
| 47 | H-5 | P-5 | D-1 |
| 48 | H-5 | P-5 | D-2 |
| 49 | H-5 | P-5 | D-3 |
| 50 | H-5 | P-5 | D-4 |

The technology may be even better understood with reference to the following non-limiting examples.

A set of examples are prepared using the following pressure sensitive adhesives (PSA), some of which are also in the tables above.

TABLE 5

| PSA | |
|---|---|
| Number | PSA Description |
| P-4 | CARBOTAC ® 2990, an acrylic polymer dispersion available |
| | from Lubrizol. |
| P-5 | CARBOTAC ® 1811, an acrylic polymer dispersion available |
| | from Lubrizol. |
| P-6 | An anionic and aliphatic waterborne polyurethane dispersion. |

The set of examples also uses the following hot-melt adhesives (HMA), some of which are also in the tables above.

TABLE 6

| HMA | |
|---|---|
| Number | HMA Description |
| H-6 | ESTANE ® 5717, a polyester TPU HMA available from |
| | Lubrizol. |
| H-7 | EVA 2240, a ethylene vinyl acetate copolymer HMA available |
| | from Hanwha |

The set of examples also uses the following designs and/or patterns for the pressure sensitive adhesive on the hot-melt adhesives:

TABLE 7

| Design | |
|---|---|
| Number | Design Description |
| D-0 | No PSA, 0% coverage. |
| D-10 | Dots, circular, in offset rows, 10% coverage |
| D-20 | Dots, circular, in offset rows, 20% coverage |
| D-30 | Dots, circular, in offset rows, 30% coverage |
| D-100A | Film, 100% coverage, in a thin layer |
| D-100B | Film, 100% coverage, in a thick later |

The set of examples also uses the following substrates where the HMA is applies to the first substrate, and the PSA is applied to the HMA in the designated design. A second substrate is then applied to the PSA layer.

TABLE 8

| Design | |
|---|---|
| Number | Substrate |
| S-1A | Thick fabric, 65/35 PET/cotton fibers |
| S-1B | Thin fabric, 65/35 PET/cotton fibers |
| S-2A | Thick mylar film |
| S-2B | Thin mylar film |
| S-3B | Thin thermoplastic polyurethane film |

A summary of the examples in provide in the table below. Each example is prepared using the specified first substrate, where the hot-melt adhesive is applied to substrate as a continuous film, at about 10 mil thick. The pressure sensitive adhesive is then applied onto the hot-melt adhesive film, in the specified pattern, at about 3 to 4 mil thick. The specified second substrate is then applied. Each example is then assembled where the pressure sensitive adhesive provides the initial and temporary adhesion between the first substrate and the second substrate which is tested for bond strength after 2 days and 5 1 kg rolls (referred to as 2 day tack), and the part is then hot-melt bonded at 85° C., where the hot-melt adhesive provides long term bonding between the substrate layers. This final bond strength is also tested. In both cases the tack and/or bond strength is tested by measured the force required to pull the second substrate away from the first substrate.

TABLE 9

| | | | | | | 2 Day | Final |
|---|---|---|---|---|---|---|---|
| Ex. | 1^{st} | | | PSA | 2^{nd} | Tack | Bond |
| No. | Subst | HMA | PSA | Design | Subst | (gf/in) | (gf/in) |
| 51 | S-1A | H-6 | P-4 | D-0 | S-1B | 0 | 11230 |
| 52 | S-1A | H-6 | P-4 | D-10 | S-1B | 87 | 8610 |
| 53 | S-1A | H-6 | P-4 | D-20 | S-1B | 136 | 9860 |
| 54 | S-1A | H-6 | P-4 | D-30 | S-1B | 284 | 8460 |
| 55 | S-1A | H-6 | P-4 | D-100A | S-1B | 32 | 7400 |
| 56 | S-1A | H-6 | P-4 | D-100B | S-1B | 500 | 1220 |
| 57 | S-1A | H-6 | P-6 | D-0 | S-1B | 0 | 11230 |
| 58 | S-1A | H-6 | P-6 | D-20 | S-1B | 9 | 10430 |
| 59 | S-1A | H-6 | P-6 | D-30 | S-1B | 14 | 10530 |
| 60 | S-1A | H-6 | P-6 | D-100A | S-1B | 12 | 9550 |
| 61 | S-1A | H-6 | P-5 | D-0 | S-1B | 0 | 11230 |
| 62 | S-1A | H-6 | P-5 | D-20 | S-1B | 73 | 10830 |
| 63 | S-1A | H-6 | P-5 | D-30 | S-1B | 157 | 6890 |
| 64 | S-1A | H-6 | P-5 | D-100A | S-1B | 21 | 3880 |
| 65 | S-2A | H-7 | P-4 | D-0 | S-2B | 0 | 0 |
| 66 | S-2A | H-6 | P-4 | D-0 | S-2B | 0 | 230 |
| 67 | S-2A | H-6 | P-4 | D-20 | S-2B | 72 | 1290 |
| 68 | S-2A | H-6 | P-4 | D-30 | S-2B | 200 | 1780 |
| 69 | S-2A | H-6 | P-4 | D-100A | S-2B | 314 | 930 |
| 70 | S-1A | H-7 | P-4 | D-0 | S-1B | 0 | 0 |
| 71 | S-2A | H-6 | P-4 | D-0 | S-3B | 0 | 7900 |
| 72 | S-2A | H-6 | P-4 | D-20 | S-3B | 260 | 5200 |
| 73 | S-2A | H-6 | P-4 | D-30 | S-3B | 670 | 4100 |
| 74 | S-2A | H-6 | P-4 | D-100B | S-3B | 1700 | 2300 |

The results show that the described technology, utilizing a PSA in a discontinuous pattern on an HMA, can provide good performance in the areas of short term tack and final bond strength, making the described technology very useful in a variety of applications. The results also show that certain combinations of HMA and PSA materials, where the PSA is applied in a dis-continuous pattern having certain features, can provide superior performance in both areas.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. An adhesive system comprising (i) a hot-melt adhesive and (ii) a pressure sensitive adhesive,
where the hot-melt adhesive is in the form of a continuous film and where the pressure sensitive adhesive is distributed on at least one surface of said continuous film in a discontinuous pattern.

2. The adhesive system of claim 1 wherein said hot-melt adhesive comprises a thermoplastic polyurethane.

3. The adhesive system of claim 1 wherein said pressure sensitive adhesive comprises an acrylic polymer dispersion.

4. The adhesive system of claim 1 where the pressure sensitive adhesive covers between 5 and 60 percent of the surface of said continuous film on which it is present.

5. An adhesive article comprising a substrate, and an adhesive system on a first major surface of the substrate, the adhesive system comprising:
(i) a hot-melt adhesive; and
(ii) a pressure sensitive adhesive;
where the hot-melt adhesive is in the form of a continuous film on said first major surface of the substrate; and
where the pressure sensitive adhesive is present on the film of hot-melt adhesive, opposite the substrate, in the form of a discontinuous layer.

6. The adhesive article of claim 5 wherein said hot-melt adhesive comprises a thermoplastic polyurethane.

7. The adhesive article of claim 5 wherein said pressure sensitive adhesive comprises an acrylic polymer dispersion.

8. The adhesive article of claim 5 where the pressure sensitive adhesive layer covers between 5 and 60 percent of the surface of said continuous film on which it is present.

9. The adhesive article of claim 5 where the substrate comprises a film, sheets, membranes, filters, nonwoven or woven fibers, hollow or solid beads, bottles, plates, tubes, rods, pipes, or wafers.

10. The adhesive article of claim 5 wherein the substrate is multilayer.

11. An article comprising one or more parts and at least one adhesive article, wherein said adhesive article, through the application of pressure, temperature, or both, combines with said parts to form said article;
wherein said adhesive article comprising a substrate, and an adhesive system on a first major surface of the substrate, the adhesive system comprising:
(i) a hot-melt adhesive; and
(ii) a pressure sensitive adhesive;
where the hot-melt adhesive is in the form of a continuous film on said first major surface of the substrate; and
where the pressure sensitive adhesive is present on the film of hot-melt adhesive, opposite the substrate, in the form of a discontinuous layer.

12. The article of claim 11 wherein said hot-melt adhesive comprises a thermoplastic polyurethane.

13. The article of claim 11 wherein said pressure sensitive adhesive comprises an acrylic polymer dispersion.

14. The article of claim 11 where the pressure sensitive adhesive layer covers between 5 and 60 percent of the surface of said continuous film on which it is present.

15. The article of claim 11 where the substrate comprises a film, sheets, membranes, filters, nonwoven or woven fibers, hollow or solid beads, bottles, plates, tubes, rods, pipes, or wafers.

16. The article of claim 11 wherein the substrate is multilayer.
